(19) United States
(12) Patent Application Publication
(10) Pub. No.: US 2013/0092076 A1
(43) Pub. Date: Apr. 18, 2013

(54) MARKER

(71) Applicant: Gilly Michael Duncan Fox, Falmouth (GB)

(72) Inventor: Gilly Michael Duncan Fox, Falmouth (GB)

(73) Assignee: SEA-CUBED LIMITED, Falmouth, Cornwall (GB)

(21) Appl. No.: 13/806,549

(22) PCT Filed: Jun. 30, 2011
(86) PCT No.: PCT/GB2011/000980

§ 371 Date: Dec. 21, 2012

(30) Foreign Application Priority Data
Jun. 30, 2010 (GB) 1010978.3
Jan. 20, 2011 (GB) 1100951.1

(51) Int. Cl. G01B 3/00

(52) U.S. Cl. CPC G01B 3/00
USPC 116/209

(57) ABSTRACT

A marker is provided for use with a plaster covering. An indicator arrangement is activated by moisture from the plaster covering to provide an indication which is visible from the exposed face of the plaster covering. This may be by swelling, releasing a dye or ink, pushing a pin through the plaster or in other ways.

The present invention relates to markers and more particularly to markers utilised with respect to plaster coverings in buildings and similar structures.

It will be understood that within buildings it is typical to provide a plasterboard or block or brick or render surface which is then at least skimmed with a plaster covering in order to provide an aesthetically pleasing flat smooth surface upon which decoration either in the form of simple paint coatings or paper can be applied. It is also important to provide utility services in terms of electrical wiring, piping for water and gas pipes within a building. It is also important to provide fixtures and fittings that are integrated into the structure of the building in terms of electrical switches, electrical fittings, radiators, boilers, cookers, fitted kitchen units, fitted wardrobes, dishwashers and washing machines within a building. Although such utility services, fixtures and fittings can be incorporated prior to applying the plasterboard or plaster coverings this pre-installation approach is not always possible or convenient.

In the above circumstances and other such construction trades such as plumbers, kitchen fitters, carpenters and electricians typically will need to attach the necessary structural supports, cables, boxes, pipes and recesses for these utility services, fixtures and fittings upon appropriately strong and robust structural components within the building structure or upon locations that are accurately identified relative to the hidden pipes or cables within the building structure. Identification of the position for such mounting or locating points can be difficult particularly subsequent to application of the plaster covering skim. Problems can occur particularly when the plaster covering skim to a base plasterboard or block or brick or render is applied. It will be appreciated prior to application of the plaster covering skim it is generally relatively easy to determine location of mounting positions such as battens within the wall structure. The plasterboard itself will generally be secured to these mounting battens or otherwise and therefore a line of fastenings will be noticeable or alternatively because the plasterboard will eventually be covered by a plaster covering skim markings can be left upon the plasterboard to indicate positions for support battens etc. Furthermore, again as the plasterboard will eventually be covered by a plaster covering skim it is even acceptable to utilise a blade or conduct a nail survey in which a small nail is tapped through the plasterboard to identify positions of increased resistance and therefore mounting battens etc. However, subsequently to applying the plaster covering skim such approaches are unacceptable as they will diminish the aesthetic appeal of the plaster covering skim and will require remedial action.

Despite the difficulties associated with identifying locating mountings after application of the plaster covering skim it will be appreciated that it is still important to identify positions to allow mounting of the utility elements as described above such as cables, pipes, boxes, recesses, fixtures and fittings. In such circumstances various techniques have been identified and utilised previously in order to find mounting positions. These processes generally are time consuming, inaccurate, unreliable and generally expensive. Examples are given below.

It is known to place matchsticks, screws or other physical markers at the point where fastenings should go but such approaches are subject to inadvertent removal of the markers prior to utilisation and inhibit plastering. A further alternative is to incorporate detectable markers which show a change in density or other characteristics which can then be located using expensive sensing equipment. A further approach as described above is to utilise a nail survey to identify appropriate mounting points but this will be time consuming and will require each hole to be filled subsequent to conducting the survey. A further alternative is to mark for example the floor or ceiling to identify by drop down or cross indicators the position for mountings within the wall but such an approach is again subject to inaccuracies and removal of the markings inadvertently or by other trades in performing their own tasks. The final approach is to take a photograph or sketch of the area prior to application of either the plasterboard or the plaster covering skim again to allow a subsequent user to identify positions for mountings. This approach is inaccurate and susceptible to loss of the sketch or photograph.

A more convenient approach for identifying location in structures is required.

In accordance with aspects of the present invention there is provided a marker for plaster coverings, the marker comprising an indicator arrangement operable when activated by moisture from a plaster covering applied across the marker, to provide an indication which is visible from the exposed face of the plaster covering.

The indicator arrangement may create movement, when activated. The movement may be outward movement toward or beyond the exposed face.

Generally, the outward indication is progressive dependent upon wetting of the indicative material. Normally, the outward indication is progressive whereby the outward indication is substantially not noticeable for at least a pre-determined time period.

Possibly, the indicator arrangement comprises a moisture swellable or shrinkable material.

Typically, the moisture swellable material is a plastic or rubber or cellulose or polymer based matrix or a combination of such materials.

Possibly, the swellable or shrinkable material may set in the deployed state. The moisture swellable or shrinkable material may be in the form of a plurality of discrete bodies of material, prior to activation. The discrete bodies may be in the form of grains or beads. Alternatively, the swellable or shrinkable material may be in the form of a single body of material, prior to activation.

The indicator arrangement may comprise an indicator member and a releasable bias arrangement operable to move the indicator member when released. The releasable bias arrangement may comprise a spring member providing bias to the indicator member and an absorbent retaining member, the retaining member serving to retain the indicator member until the retaining member is weakened or dissolved by moisture absorption to allow the spring member to move the indicator member. The indicator member may be a pin which is pushed through the plaster layer to provide the visual indication.

The pin may extend beyond the plaster covering and/or provide reinforcement within the plaster covering. The pin can be removed to provide a pilot hole for a fastening or fixing arrangement.

Alternatively the indicator arrangement may comprise an ink or dye release material. Further alternatively the identifier material has a greater specific water absorption capacity.

The marker may be formed to penetrate a surface over which plaster is to be applied, prior to the application of the plaster. The marker may comprise a cup to receive the indicator arrangement. Generally, the cup is associated with a fixing. Typically the fixing comprises a cleat or other penetration member. Alternatively, the fixing comprises an adhesive. Further alternatively, the fixing comprises a plurality of grip spikes. Possibly, an external surface of the cup incorporates grip elements comprising laterally extending ribs. Possibly, the laterally extending ribs define a screw thread.

Possibly, the recess has a closure across the recess.

Generally, the closure provides a percussive surface upon which the recess can be percussively driven whilst the identifier material is protected within the recess.

The indicator arrangement may comprise attachment means operable to attach the indicator arrangement to a surface over which plaster is to be applied. The attachment means may be adhesive. The attachment means may comprise an adhesive layer covered, initially, by a removable protective layer.

Possibly, the indicator arrangement has a covering. Typically, the covering is dissolvable by moisture. Possibly, the covering comprises a film or coating applied across an open end of the recess. The covering may act to delay a response by the indicator arrangement to moisture for a desired time period. Generally, the indicator arrangement is chosen in terms of material type and/or volume operable to provide at least a noticeable distortion and/or contour variation in the plaster covering in use after one to two hours.

Possibly, the recess is shaped to enhance outward expansion in one axis. Possibly, the recess is tapered. Also in accordance with aspects of the present invention there is provided a marker arrangement comprising a marker as described above associated with a plasterboard.

Typically the arrangement incorporates a plaster covering of sufficient depth to provide moisture to the indicator arrangement to provide an outward indication.

Generally, the outward indication provides a noticeable bump and/or crack and/or hole and/or crater and/or depth and/or colour change in the plaster covering. Possibly, the outward indication can be sanded or abraded for removal in the arrangement.

Generally, the recess is formed from a plastic material or alternatively a metal.

Aspects of various embodiments of the present invention will now be described by way of example only with reference to the accompanying drawings in which:

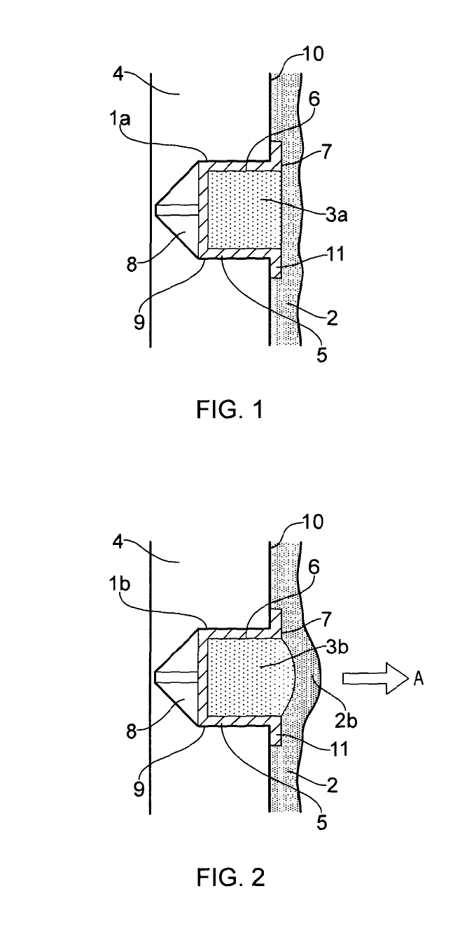

FIG. 1 is a schematic side cross section of a marker in accordance with aspects of the present invention just prior to activation;

FIG. 2 provides a schematic illustration of the marker depicted in FIG. 1 after activation;

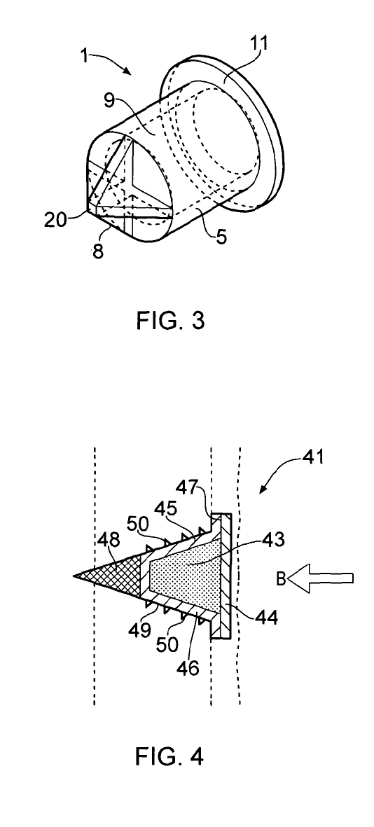

FIG. 3 provides a reverse perspective view of a cup to define a recess for an indicator arrangement such as a moisture swellable material in accordance with aspects of the present invention;

FIG. 4 provides a schematic illustration of alternatives with regard to a marker in accordance with aspects of the present invention;

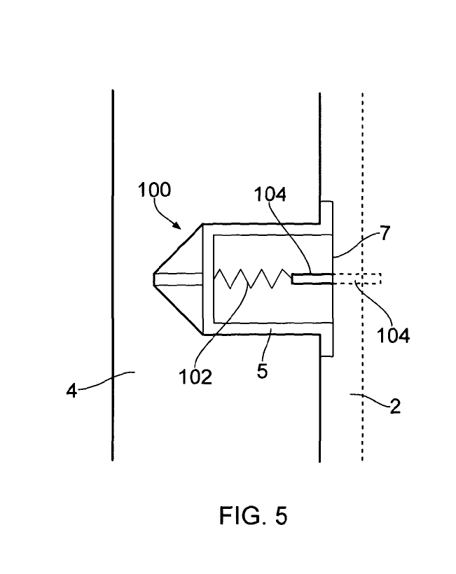

FIG. 5 is a schematic diagram of an alternative marker using mechanical activation; and

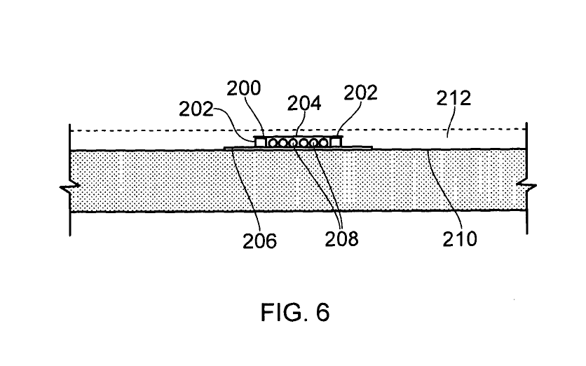

FIG. 6 is a schematic diagram of the use of an alternative marker which is surface-mounted.

As described above location of mountings or additionally positioning of recesses for electrical junction boxes etc has particular advantages. However, such indications should not overly diminish the aesthetic appeal of a plaster covering skim applied to a plasterboard or block or brick or rendered surface. In such circumstances in accordance with aspects of the present invention a marker is provided which is activated by the moisture content within a plaster coating. It will be understood that the plaster is applied in a wet state and smoothed appropriately upon the base plasterboard or block or brick or render. In such circumstances the plaster coating will dry to leave a smooth surface suitable for decoration.

Typically, a plasterer will apply a first base layer of plaster and then over a period of time typically in the order of 20 minutes will progressively smooth that plaster to a fine smooth or mirror like finish. In such circumstances indicators in accordance with aspects of the present invention should have a delay with regard to providing an indication for at least the period during which the plasterer smoothes the plaster covering skim to a fine finish. As indicated later generally the predetermined time period by which the marker should be fully operational and therefore an outward indication given will be in excess of one or two hours.

FIGS. 1 and 2 illustrate one example of a marker in accordance with aspects of the present invention. FIG. 1 illustrates the marker 1a just prior to activation by a plaster covering skim 2. FIG. 2 illustrates the marker 1b after activation by the moisture content of the plaster covering 2. As indicated above there will be a pre-determined time period of at least twenty minutes but more usually an hour or two before the outward indication is noticeable upon applying a plaster covering skim. In the pre-determined time period or longer the marker will develop from the state depicted in FIG. 1 to that depicted in FIG. 2. The example given is with regard to a moisture swellable material as the indicator arrangement 3 but other indicator arrangements could release a dye or ink which leaches through to mark the surface of the plaster covering 2 or the indicator arrangement could contract to provide a dimple or crater as a marker or the indicator arrangement could have a relatively high moisture absorption level to give an overly dried patch in an outward indication. There is a wide range of alternative indicator arrangements including other chemical, mechanical, electrical and thermally responsive arrangements to moisture wetting by the plaster skim with a delayed response.

The moisture swellable material has expanded in the direction of arrowhead A to distort and raise as a bump 2b a part of the plaster covering skim 2. The raised or bump portion 2b will be readily identifiable by a tradesman such as plumber, carpenter, electrician or kitchen fitter by viewing the exposed face of the plaster coverings in order to identify the location. In such circumstances markers 1 in accordance with aspects of the present invention will be punched or otherwise located within a plasterboard 4 to locate position as indicated with respect to mounting points or where already incorporated features such as back boxes for electrical equipment etc. Generally the markers 1 provide a reference point through the raised portion 2b in the plaster covering 2 which will be utilised by tradesmen.

In order to avoid problems with regard to the plasterer achieving his desirable surface as indicated marks in accordance with aspects of the present invention will be designed to be responsive after an appropriate time delay for a pre-determined time period. Such time delay as described previously may be through providing an optional surface film or coating which is dissolved by the moisture content of the plaster applied to delay activation of the indicative material for that time period. In such circumstances whilst the plasterer works the plaster covering skim there will be no noticeable effect upon the plaster surface diminishing from the desired surface result. However, after the pre-determined time period or longer an outward indication will be provided as to location.

This outward indication may result in some cracking of the plaster covering skim but generally as indicated markers in accordance with aspects of the present invention will be utilised to indicate positions for mountings or underlying utilities such as cables. In such circumstances the fixings may be screwed through the marker obscuring or obliterating any cracking in the plaster covering skim. Where cracking may be a problem it may be possible as described below to provide an outward projection of a pin through the plaster. In such circumstances the pin will be removed to leave a pilot hole which can then be filled or more probably that pilot hole can act as a guide for attaching a fastener such as a screw.

As will be described later possibly markers in accordance with aspects of the present invention will be formed from a plastics or polymer material or a cellulose material such that these materials will act as plugs to allow robust association of fasteners and avoid any diminution in the surface integrity of the structure covered by the plasterboard and/or plaster covering skim. Thus, any fastening that goes in the location of the marker will be principally retained by the substrate behind the marker i.e. the wooden stud, wooden batten or other structural material behind the marker. The marker is designed such that a screw or nail fastening can easily pass through it in order to reach the substrate behind.

Markers in accordance with aspects of the present invention may also incorporate specific plugging materials to facilitate robust association with mountings and fasteners.

The marker 1 comprises a cup 5 which defines a recess 6 within which the moisture swellable material 3 or other indicator material is located. It will be noted that the moisture swellable material 3 extends to an open end with a film or coating 7 across the moisture swellable material 3. The film or coating 7 is optional, and when used, will protect the moisture swellable material 3 or other indicator arrangement before and upon installation. The film or coating 7 will be dissolvable in the moisture presented by the plaster covering 2. An additional cover, which may be a detachable stick on or otherwise water ingress barrier may also be provided for transportation and storage such that the film or covering 7 and more particularly the moisture swellable material 3 are not activated by air moisture or accidental exposure to water.

The marker 1 also incorporates a fixing member 8 to enable the marker 1 to penetrate the plasterboard 4. The fixing member 8 may include a penetrative element or anchor as will be described later in more detail with respect to FIG. 3.

Referring to FIG. 1 as indicated the marker 1a has been located within a plasterboard 4. This location may be achieved by drilling a hole or more normally through percussive action. In view of the penetrative nature of the fixing 8 and if the marker 1 is of a relatively small size it will be appreciated that finger or thumb pressure may simply be utilised in order to force the marker 1 into the plasterboard 4. Alternatively, more severe percussive impact may be achieved through use of a hammer or locating gun using a compressed air ram. Further alternatives include providing a screw thread (not shown) on an external surface 9 of the cup 5 to enable the marker to be screwed into location. Once located in the plasterboard 4 the marker 1 will generally sit in a flush location to an external surface 10 of the plasterboard 4. In such circumstances the plaster covering 2 can then be applied. Until the plaster covering 2 is applied it will be understood that the film or coating 7, if present, will act to inhibit atmospheric moisture action upon the moisture swellable material 3 or other indicator arrangement. However, once the plaster covering 2 is applied the far greater moisture content of the plaster 2 will dissolve the film or coating 7 such that the moisture will then activate the moisture swellable material 3 or other indicator arrangement and cause an outward indication. That is, the indication is visible from the exposed face of the plaster covering 2.

The outward indication as indicated in FIG. 2 is generally in one direction due to the constriction of the cup 5. With the moisture swellable material 3 the outward indication is an expansion.

In order to ensure appropriate presentation of the expansion of the moisture swellable material 3 typically flange portions 11 are provided in the cup 5. It will be understood that the moisture swellable material 3 will expand and it is preferable that this expansion is generally in the direction of arrowhead A. Nevertheless, the plaster covering 2 is formed from relatively dense material and therefore may have an inherent resistance unless the marker 3 is appropriately anchored through the flanges 11. The resistance of the plaster covering 2 may result in at least a potential for further inward penetration in the opposite direction to arrowhead A as a result of the reaction forces created by the expansion of the material 3 unless the flanges 11 inhibit such reaction. It will also be appreciated that providing external flanges on the surface 9 which may include the screw threads as described or otherwise will stabilise of the marker 1 inwardly and therefore maximise the amount of outward displacement by the moisture swellable material 3 in the direction of arrowhead A.

If a hole or aperture is created within the plasterboard 4 it will be appreciated that alternatives such as utilisation of an adhesive or simple plug association may be utilised for positioning the marker 1. However, drilling of a hole or creation of a recess will add significantly to the complexity of providing the marker 1 in the plasterboard and therefore a simple percussive penetrative assembly will be preferred.

The moisture swellable material 3b will generally be formed from a plastics or polymer or rubber or cellulose such as paper based material or a combination. It will be understood that the moisture from the plaster covering 2 will generally expand elements within the moisture swellable material to cause the expansion in the direction of arrowhead A. Clearly, generally the moisture swellable material 3a adjacent to the opening to the recess 6 will be in first contact with the moisture from the plaster covering 2. In order to ensure expansion throughout the depth of the moisture swellable material 3 possibly straws or other means for transfer of moisture from the surface regions of the material 3 to greater depths within the material 3 may be provided. Alternatively, combinations of moisture expandable elements as well as moisture transfer materials which will wick moisture to the greater depths within the material 3 may be incorporated within the material 3 to ensure appropriate expansion in the direction of arrowhead A. It will also be understood that the indicative material may be presented as a cylinder or tower either initially by removal of a protective sleeve before plastering or as a tower linked to the inner surface of the recess 6 by supporting arms or as the material develops during swelling beyond the recess. Thus, the plaster will surround the material and respond more appropriately in a progressive manner to provide the outward indication.

The moisture expandable material may be in solid form or granular form dependent upon requirements. Clearly, in granular form the covering or film 7, or some other mechanism, must be sufficient to retain the granular material within the recess 6. In such circumstances the covering or film 7, if used, may comprise a more resilient mesh to restrain the granular material with an overlying film of dissolvable material to allow moisture access. In such circumstances as described above the mesh may flex and expand or remain in place throughout activation of the moisture swellable material 3b.

With the bump 2b visible as indicated a tradesman can utilise this to locate mountings or already installed fixtures such as back boxes within a surface incorporating the plasterboard 4. Subsequent to appropriate actions the bump 2b will be of such dimensions to allow smoothing through sanding or abrasion or application of a further plaster skim layer or the outward indication removed when making a recess such as for a back box for an electrical switch or socket.

By aspects of the present invention it will be appreciated that a quick, accurate and cheap whilst reliable arrangement is provided to enable marking within a building surface. By such markings around potential problems with regard to breaching pipes or cables either in attempting to locate utilities such as pipes or cables or during a nail survey are avoided. It will be appreciated that typically a short time span is provided between dry lining and fitting of the plastic marker such that even if of a temporary nature these can be easily identified to pinpoint locations within the plasterboard 4/plastercovering 2. Furthermore, markers 1 in accordance with aspects of the present invention can be applied as part of a dry lining process by utilisation of markers in accordance with aspects of the present invention these markers can be incorporated post application of the plaster covering 2 such that it is possible to choose to fit certain fixtures after decorating if this is most appropriate in terms of achieving a suitable standard of finish and avoid reworking.

FIG. 3 provides a rear perspective view of the marker 1 depicted in FIG. 1 and FIG. 2. In such circumstances it will be noted that the marker 1 generally comprises a cylinder within which the cup 5 is created with an external surface 9. This external surface 9 may be smooth or as indicated above incorporate outwardly extending ribs or screw threads to provide location within a plasterboard (not shown). The flange 11 both provides a laterally extending reaction surface to prevent inward penetration as a result of swelling of the moisture swellable material but also similarly acts to restrict the depth of penetration for the marker 1 into the plasterboard (not shown).

The fixing members 8 comprise wedge sections which extend to a point 20 to allow location within the plasterboard (not shown).

The cup 5 will generally be formed from a robust material. In such circumstances the cup 5 may be formed from a robust plastics material or metal. It is important that the cup 5 is robust in order to concentrate and direct expansion or other indication as indicated above with regard to FIG. 2 in the direction of arrowhead A. However, in some circumstances at least slight outward expansion may be acceptable to further provide reaction and inhibit inward displacement of the reaction to the expansion of the moisture swellable material 3 in use.

As indicated above generally the degree of expansion by the moisture swellable material 3 will be chosen dependent upon the material as well as the volume of material within the recess 6 of the cup 5. In order to utilise the correct marker 1 in accordance with aspects of the present invention markers or different colour or numbering may be provided such that the appropriate marker can be utilised for the particular arrangement in terms of plaster type or expansion requirements in terms of creating a bump 2b (FIG. 2) or other outward indication.

A simple press stud type arrangement as depicted in FIGS. 1 to 3 will generally be advantageous in terms of manufacture and usage. However, FIG. 4 illustrates some alternatives in accordance with aspects of the present invention which may facilitate specific improvements with regard to particular arrangements of markers in accordance with aspects of the present invention.

A marker 41 as depicted in FIG. 4 incorporates as indicated several alternatives. Some of these alternatives may be utilised with regard to markers in accordance with aspects of the present invention.

A cup 45 may be provided within which a recess 46 is tapered away from an open end such that expansion of a moisture swellable material 43 is maximised.

In order to improve penetration in comparison with the simple cleat type wedges utilised for fixing members 8 as described previously with regard to FIGS. 1 to 3 an alternative as depicted in FIG. 4 would be to provide a pyramid or wedge shape in which an end or tip 48 is formed from a metal. In such circumstances application of a percussive force in the direction of arrowhead B may allow easier location within a plasterboard (not shown) or other surface material in accordance with aspects of the present invention. Such an approach may also allow the marker to be used as a fixing for the plasterboard itself.

As previously a film or coating 47 may be provided to retain and/or protect the moisture swellable material 43 or other indicative material during storage and transportation. However, and additionally, a closure 44 may also be added. This closure 44 may be secured through a temporary adhesive or other means to enable a percussive force through use of a hammer or mechanical gun to drive the marker 41 into a surface such as plasterboard. Once located the closure 44 can be removed to expose the film 47 or the material 43. As described previously the film 47, if present, will then dissolve in the moisture taken from the plaster materials utilised to form the plaster covering and applied in use over a marker in accordance with aspects of the present invention. The closure will typically be robust to protect both the film 47 and the moisture swellable material 43 or other indicative material until plaster is applied.

As indicated above generally a film or coating 7, 47 will be optionally applied in order to prevent early expansion of the moisture expandable material 3, 43 or activation of the indicator arrangement as a result of atmospheric moisture and humidity. In such circumstances a balance must be drawn between providing an adequate protective film or coating and the capability of the plaster material to initially dissolve that film or coating and then allow expansion of the moisture swellable material or activation of another indicator arrangement. Such considerations may complicate choices with respect to both the film and the moisture expandable or other indicative material. In such circumstances utilisation of an initial wash or sizing of the plasterboard prior to application of the plaster covering may be utilised in order to initially dissolve or at least prime the film or coating for more rapid dissolving.

As indicated above addition of lateral ribs 50 to an external surface 49 of the cup 45 may ensure greater retention of the marker 41 in use. These ribs or lateral extensions 50 may also provide a screw thread to allow association of the marker within the plasterboard or another surface. In such circumstances the closure 44 or other parts such as flanges to the marker and in particular the cup 45 may allow rotation and therefore location of the marker within the plasterboard or other surface.

As indicated above generally the moisture swellable or other indicator arrangement in accordance with aspects of the present invention will be arranged to expand or provide an outward indication substantially in one axis or direction in order to maximise the indication e.g. bump (FIG. 2) created for marking locations within the plaster covering 2. In some circumstances it may be more desirable to provide a pin or other mechanical element which extends in the same direction to pass through the plaster covering 2 in order to be exposed in use.

An example which uses a mechanical indicator arrangement is shown in FIG. 5. Many features correspond with those described above, particularly in relation to FIG. 1 and FIG. 2 and in those circumstances, the same reference numerals are used again. In this example, the marker 100 is located within a plasterboard in order to be covered by a plaster covering 2, as described above. The marker 100 comprises a cup 5 covered by a soluble barrier 7 which can dissolve in the presence of moisture, particularly moisture drawn from the plaster covering 2. As noted above, an additional cover (not shown) may be provided for transportation and storage, to prevent activation of the barrier 7. Within the cup 5, there is a spring 102 and pin 104. Prior to use, the pin 104 is retained within the cup 5 by the presence of the barrier 7 and in this condition, the spring 102 is in compression. Thus, the spring 102 provides bias seeking to push the pin 104 out of the cup 5, but the pin 104 is retained by the presence of the barrier 7. The barrier 7 thus serves as a retaining member.

However, when the plaster covering 2 is applied and makes contact with the barrier 7, moisture from the plaster covering begins to dissolve the barrier 7. This weakens the barrier 7, until it is no longer capable of withstanding the bias force provided by the spring 102, or dissolves away completely. The pin 104 can then be forced forward by the spring 102. The pin 104 may move through the plaster 2 to project beyond the visible face of the plaster, or may push the plaster 2 to form a visible bump in the plaster 2. In one example, multiple pins 104 may be provided, to be pressed into the plaster layer 2 to provide a visible bump in the plaster layer 2, and also to provide local reinforcement of the plaster 2, so that subsequent installation of a fixing can be achieved with lower risk of cracking of the plaster 2.

In each of the examples illustrated in FIGS. 1 to 5, the marker is installed by penetrating into the plasterboard 4. Thus, the marker penetrates the surface over which plaster 2 is to be applied, prior to the application of the plaster. FIG. 6 illustrates an alternative example, which is surface mounted. In this example, the marker 200 includes a ring 202 backed by a backing member 206. The ring 202 and backing member 206 form a container for moisture swellable material 208. A soluble barrier 204 is optionally provided.

The backing member 206 serves to attach the member 200 to the surface 210 of the plasterboard 212. In one example, the backing member 206 is a sheet carrying an adhesive layer which is initially covered by a removable protective layer. After removal of the protective layer, to expose the adhesive layer, the marker 200 becomes a self-adhesive component for convenient attachment to the surface 210.

In this example, the ring 202 may be a ring of dimensionally stable material to provide mechanical stability to marker 200. Use of the term “ring” is not intended to imply that any particular shape is essential.

The optional soluble barrier 204 may be as the soluble barrier 7 described above.

The swellable material 208 is illustrated, in this example, as a plurality of discrete bodies of material, prior to activation. These may be in the form of grains, spheres or beads. The use of discrete bodies is expected to increase the ratio of the surface area to the volume of swellable material thus enhancing the ability of the swellable material to absorb moisture and become activated. For these or other reasons, discrete bodies of material, grains, spheres or beads, etc could be used alternatively in the examples described above, or the example of FIG. 6 could use a single body of swellable material.

When the example illustrated in FIG. 6 is used, the protective layer is removed from the backing member 206 to allow the member 200 to be adhered to the surface 210, at the required location. A layer of plaster 212 is then applied across the surface 210, covering the surface 210 and the member 200. At this point, if there is a soluble barrier 204 present, the swellable material 208 is protected from activation by the presence of the soluble barrier 204. Moisture from the plaster 212 will then begin to dissolve the barrier 204 until eventually moisture from the plaster 212 can reach the swellable material 208. Alternatively, moisture from the plaster may be immediately available to the swellable material 208, if no soluble barrier 204 is initially present. Once moisture has reached the swellable material 208, the material is activated to swell to raise a bump in the plaster 212, thereby providing an indication which is visible from the exposed face of the plaster 212.

A member similar to the example of FIG. 6, formed with a retaining ring of material containing the swellable material, could alternatively be fixed in position by partially or fully penetrating the surface 210.

In any of the examples described above, the barrier may be a structural element made of a material such as those used to encapsulate pharmaceuticals, or may be a moisture soluble film, or a combination of these. The use of soluble barriers is optional in all of the examples which use swellable material. A soluble barrier allows the performance of the member to be tuned in relation to the speed with which swelling occurs. This is also affected by the choice of swellable material. The speed required will depend on factors such as the plaster mix being used, environmental conditions, etc.

As indicated above a moisture swellable material is preferred to act as the indicator arrangement. However, it is an outward indication which is desired so a colour change could be used, achieved by a dye or ink released from the marker to permeate through the plaster until visible. Furthermore, electrical or chemical or mechanical or thermally actuated indicator arrangements could be used which are actuated by moisture content within the plaster covering.

In view of the situation with regard to a plasterer applying the plaster covering skim as indicated it is desirable that there is a time delay of sufficient period to enable the plasterer to perform his tasks before the marker is activated in order to provide an outward indication in the plaster covering skim. This period will depend upon requirements but generally will result in the marker being activated after at least one hour although shorter time periods may be acceptable in other circumstances. Generally, there are two time periods. The first is the period during which the activation of the marker must not interfere with the plasterer's successful plastering activities. This varies but is usually around 20 minutes. The second period is the subsequent time it takes for the marker to show itself through the plaster in some way. This could be anything from 20 minutes to 2 days depending on the design of the marker and the thickness of the plaster. It will be noted that ‘activation’ (i.e. the dissolving of the water soluble film) and/or initial absorption by the swellable material could occur the instant the plaster is applied. For example, swellable material may take a while to respond to the moisture (say between 20 minutes and 2 days). Other indicator arrangements may act immediately and thus require a delay mechanism to slow the penetration of moisture from the plaster to the indicator arrangement.

Arrangements where mechanical displacement of a pin or other element may be advantageous include where that pin or other element can be removed in order to leave a pilot hole or otherwise within which a fastening member such as a screw or screw thread can be associated.

The indicator arrangement as indicated will be activated by the moisture and therefore it will be understood that the moisture in addition to wetting may also allow electrical current flow to create heat and therefore stimulate the indicative means or the moisture may create a mechanical displacement through generating a gas or physical displacement of a plug or other member as a result of incident moisture.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A marker for plaster coverings, the marker comprising an indicator arrangement operable when activated by moisture from a plaster covering applied across the marker, to provide an indication which is visible from the exposed face of the plaster covering.

2. A marker according to claim 1, wherein the indicator arrangement is operable to create movement, when activated.

3. A marker according to claim 2, wherein the movement is outward movement toward or beyond the exposed face.

4. A marker according to claim 1, wherein the outward indication is progressive, dependent upon wetting of the indicator arrangement.

5. A marker according to claim 1, wherein the outward indication is progressive whereby the outward indication is substantially not noticeable for at least a pre-determined time period.

6. A marker according to claim 1, wherein the indicator arrangement comprises a moisture swellable or shrinkable material.

7. A marker according to claim 6, wherein the moisture swellable material is a plastic or rubber or cellulose or polymer based matrix or a combination of such materials.

8. A marker according to claim 6, wherein the swellable or shrinkable material is settable in the deployed state.

9. A marker according to claim 6, wherein the moisture swellable or shrinkable material is in the form of a plurality of discrete bodies of material, prior to activation.

10. A marker according to claim 9, wherein the discrete bodies are in the form of grains or beads.

11. A marker according to claim 6, wherein the swellable or shrinkable material is in the form of a single body of material, prior to activation.

12-17. (canceled)

18. A member according to claim 1, wherein the indicator arrangement has a greater specific water absorption capacity than the plaster covering.

19. A marker according to claim 1, formed to penetrate a surface over which plaster is to be applied, prior to the application of the plaster.

20. A marker according to claim 1, comprising a cup to receive the indicator arrangement.

21. A marker according to claim 20, wherein the cup is associated with a fixing.

22. (canceled)

23. A marker according to claim 21, wherein the fixing comprises an adhesive.

24-26. (canceled)

27. A marker according to claim 1, comprising a recess for receiving the indicator arrangement, and a closure across the recess.

28. (canceled)

29. A marker according to claim 1, wherein the indicator arrangement comprises attachment means operable to attach the indicator arrangement to a surface over which plaster is to be applied.

30. A marker according to claim 29, wherein the attachment means is adhesive.

31. A marker according to claim 29, wherein the attachment means comprise an adhesive layer covered, initially, by a removable protective layer.

32. A marker according to claim 1, wherein the indicator arrangement has a covering.

33. A marker according to claim 32, wherein the covering is dissolvable by moisture.

34. A marker according to claim 32, wherein the covering comprises a film or coating applied across an open end of a recess for the indicator arrangement.

35. A marker according to claim 32, wherein the covering acts to delay a response by the indicator arrangement to moisture for a desired time period.

36. A marker according to claim 1, wherein the indicator arrangement is chosen in terms of material type and/or volume operable to provide at least a noticeable distortion and/or contour variation in the plaster covering in use after one to two hours.

37. A marker according to claim 1, comprising a recess shaped to enhance outward expansion of the indicator in one axis.

38. (canceled)

39. A marker arrangement comprising a marker as defined in claim 1, associated with a plasterboard.

40. An arrangement according to claim 39, wherein the arrangement incorporates a plaster covering of sufficient depth to provide moisture to the indicator arrangement to provide an outward indication.

41. An arrangement according to claim 40, wherein the outward indication provides a noticeable bump and/or crack and/or hole and/or crater and/or depth and/or colour change in the plaster covering.

42. (canceled)

43. An arrangement according to claim 40, comprising a recess for the indicator arrangement, the recess being formed from a plastic material or alternatively a metal.

44-45. (canceled)
